(19) United States
(12) Patent Application Publication
(10) Pub. No.: US 2025/0029366 A1
(43) Pub. Date: Jan. 23, 2025

(54) ACTION CLASSIFICATION APPARATUS, ACTION CLASSIFICATION METHOD, AND NON-TRANSITORY STORAGE MEDIUM

(71) Applicant: NEC Corporation, Minato-ku, Tokyo (JP)

(72) Inventor: Noboru YOSHIDA, Tokyo (JP)

(73) Assignee: NEC Corporation, Minato-ku, Tokyo (JP)

(21) Appl. No.: 18/708,684

(22) PCT Filed: Nov. 17, 2021
(86) PCT No.: PCT/JP2021/042229

§ 371 Date: May 9, 2024

(51) Int. Cl. G06V 10/764; G06T 7/20; G06T 7/70; G06V 10/44; G06V 10/74

(52) U.S. Cl. CPC G06V 10/764; G06T 7/20; G06T 7/70; G06V 10/44; G06V 10/761; G06V 2201/07

(57) ABSTRACT

The present invention provides an action classification apparatus (10) including: an extraction unit (11) that extracts, from a moving image, a plurality of human movements presented in any number of frames; a time-series feature value computation unit (12) that computes a time-series feature value for the any number of frames by computing, for each of the extracted human movements, a feature value of a human pose in each of the any number of frames; a similarity computation unit (13) that computes a similarity between a plurality of the time-series feature values; and a classification unit (14) that classifies the plurality of extracted human movements, based on the similarity.

### TECHNICAL FIELD The present invention relates to an action classification apparatus, an action classification method, and a program.

### BACKGROUND ART

Techniques relevant to the present invention is disclosed in Patent Documents 1 to 3 and in Non-Patent Document 1.

In Patent Document 1, a technique for computing a feature value of each of a plurality of key points of a human body included in an image, and classifying a plurality of poses and a plurality of movements of the human body extracted from the image by collecting similar poses and movements, based on the computed feature value, is disclosed.

In Patent Document 2, a technique for classifying, based on a feature value of time-series position data of a user for each day, movement pattern of the user for each day into a plurality of clusters is disclosed.

In Patent Document 3, a technique for classifying time-series position data of a human body part into a plurality of position data groups, and analyzing a motion for each of the plurality of position data groups is disclosed.

A technique related to skeleton estimation on a person is disclosed in Non-Patent Document 1.

### RELATED DOCUMENT

### Patent Document

Patent Document 1: International Patent Publication No. WO2021/084677

Patent Document 2: International Patent Publication No. WO2017/187584

Patent Document 3: Japanese Patent Application Publication No. 2021-022323

### Non-Patent Documents

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pp. 7291-7299

### DISCLOSURE OF THE INVENTION

### Technical Problem

When classifying human movements presented in a plurality of frames by collecting similar movements, it is necessary to compute a similarity between two movements. The technique for computing a similarity between two movements disclosure in Patent Document 1 presumes that the two movements are presented by a same number of frames. A limitation that all movements to be classified are presented in a same number of frames is not convenient. None of Patent Documents or Non-Patent Document discloses this problem and a solution thereof.

The present invention is to improve convenience of a technique for classifying human movements presented in a plurality of frames by collecting similar movements.

### Solution to Problem

According to the present invention, an action classification apparatus is provided, including:
an extraction unit that extracts, from a moving image, a plurality of human movements presented in any number of frames;
a time-series feature value computation unit that computes a time-series feature value for any number of frames by computing, for each of the extracted human movements, a feature value of a human pose in each of the any number of frames;
a similarity computation unit that computes a similarity between a plurality of the time-series feature values; and
a classification unit that classifies a plurality of extracted human movements, based on the similarity.

Further, according to the present invention, an action classification method is provided, including,
by a computer, executing:
an extraction step of extracting, from a moving image, a plurality of human movements presented in any number of frames;
a time-series feature value computation step of computing a time-series feature value for any number of frames by computing, for each of the extracted human movements, a feature value of a human pose in each of the any number of frames;
a similarity computation step of computing a similarity between a plurality of the time-series feature values; and
a classification step of classifying a plurality of extracted human movements, based on the similarity.

Further, according to the present invention, a program is provided, causing a computer to function as:
an extraction unit that extracts, from a moving image, a plurality of human movements presented in any number of frames;
a time-series feature value computation unit that computes a time-series feature value of any number of frames by computing, for each of the extracted human movements, a feature value of a human pose in each of the any number of frames;
a similarity computation unit that computes a similarity between a plurality of the time-series feature values; and
a classification unit that classifies a plurality of extracted human movements, based on the similarity.

### Advantageous Effects of Invention

According to the present invention, convenience of a technique for classifying human movements presented in a plurality of frames by collecting similar movements is improved.

### BRIEF DESCRIPTION OF THE DRAWINGS

The above-described object, another object, a characteristic, and an advantage will be further clarified by public example embodiments described in the following and the following diagrams accompany therewith.

FIG. 1 It is a diagram illustrating one example of a hardware configuration of an action classification apparatus according to the present example embodiment.

FIG. 2 It is a diagram illustrating one example of a function block diagram of the action classification apparatus according to the present example embodiment.

FIG. 3 It is a diagram schematically illustrating one example of information to be processed by the action classification apparatus according to the present example embodiment.

FIG. 4 It is a flowchart illustrating one example of a flow of processing by the action classification apparatus according to the present example embodiment.

FIG. 5 It is a diagram for describing one example of extraction processing of a human movement by the action classification apparatus according to the present example embodiment.

FIG. 6 It is a diagram for describing one example of extraction processing of a human movement by the action classification apparatus according to the present example embodiment.

FIG. 7 It is a diagram illustrating one example of a skeleton structure of a human body model detected by the action classification apparatus according to the present example embodiment.

FIG. 8 It is a diagram illustrating one example of a skeleton structure of a human body model detected by the action classification apparatus according to the present example embodiment.

FIG. 9 It is a diagram illustrating one example of a skeleton structure of a human body model detected by the action classification apparatus according to the present example embodiment.

FIG. 10 It is a diagram illustrating one example of a skeleton structure of a human body model detected by the action classification apparatus according to the present example embodiment.

FIG. 11 It is a diagram illustrating one example of a feature value of a key point computed by the action classification apparatus according to the present example embodiment.

FIG. 12 It is a diagram illustrating one example of a feature value of a key point computed by the action classification apparatus according to the present example embodiment.

FIG. 13 It is a diagram illustrating one example of a feature value of a key point computed by the action classification apparatus according to the present example embodiment.

FIG. 14 It is a flowchart illustrating one example of a flow of processing by the action classification apparatus according to the present example embodiment.

FIG. 15 It is a diagram for describing determination processing of a correlation of frames by the action classification apparatus according to the present example embodiment.

FIG. 16 It is a flowchart illustrating one example of a flow of processing by the action classification apparatus according to the present example embodiment.

FIG. 17 It is a diagram for describing extraction processing of a key frame by the action classification apparatus according to the present example embodiment.

FIG. 18 It is a diagram for describing extraction processing of a key frame by the action classification apparatus according to the present example embodiment.

FIG. 19 It is a diagram for describing a key-relevance frame, a time interval between a plurality of key frames, and a time interval between a plurality of key-relevance frames according to the present example embodiment.

FIG. 20 It is a diagram illustrating one example of a screen output by the action classification apparatus according to the present example embodiment.

### DESCRIPTION OF EMBODIMENTS

In the following, example embodiments of the present invention will be described with reference to the drawings. Note that, in all the drawings, a similar component is denoted with a similar reference sign, and description thereof is omitted as appropriate.

### First Example Embodiment

### “Outline”

An action classification apparatus according to the present example embodiment computes a similarity between human movements presented in any number of frames, and classifies, based on a computation result, a plurality of movements by collecting similar movements. In a case of the present example embodiment, a movement to be classified may be presented in any number of frames. In comparison to a case in which the number of frames in which a movement to be classified is presented is limited to one specific value, convenience is improved.

### “Hardware Configuration”

Next, one example of a hardware configuration of the action classification apparatus will be described. Each function unit of the action classification apparatus is achieved by any combination of software and hardware, mainly including a central processing unit (CPU) of any computer, a memory, a program loaded onto the memory, a storage unit, such as a hard disk, storing the program (in addition to a program stored in advance from a stage of shipping an apparatus, a program downloaded from a storage medium such as a compact disk (CD) or from a server on the Internet can also be stored), and an interface for network connection. Further, it is understood by a person skilled in the art that there are various modification example of a method and an apparatus for achieving the action classification apparatus.

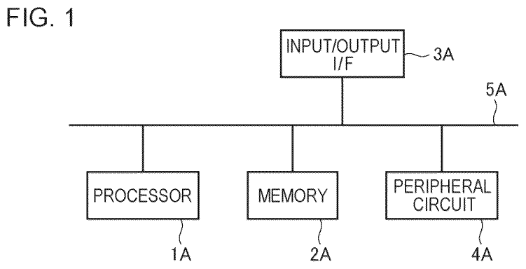

FIG. 1 is a block diagram illustrating a hardware configuration of the action classification apparatus. As illustrated in FIG. 1, the action classification apparatus includes a processor 1A, a memory 2A, an input/output interface 3A, a peripheral circuit 4A, and a bus 5A. The peripheral circuit 4A includes various modules. The action classification apparatus may not include the peripheral circuit 4A. Note that, the action classification apparatus may be configured of a plurality of apparatuses that are physically and/or logically separated. In this case, each of the plurality of apparatuses can be provided with the above-described hardware configuration.

The bus 5A is a data transmission path for the processor 1A, the memory 2A, the peripheral circuit 4A, and the input/output interface 3A to transmit and receive data to and from one another. The processor 1A is, for example, an arithmetic operation processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue instruction to each module and execute arithmetic operation, based on a result of arithmetic operation by each module.

### “Functional Configuration”

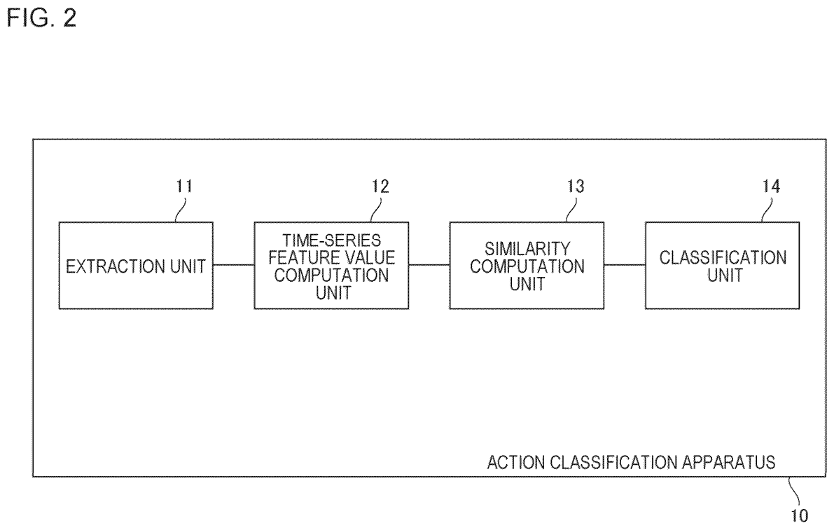

One example of a function block diagram of an action classification apparatus 10 according to the present example embodiment is illustrated in FIG. 2. The illustrated action classification apparatus 10 includes an extraction unit 11, a time-series feature value computation unit 12, a similarity computation unit 13, and a classification unit 14.

The extraction unit 11 extracts, from a moving image, a plurality of human movements presented in any number of frames, and stores an extraction result in a storage unit. The storage unit may be provided in the action classification apparatus 10, or may be provided in an external apparatus configured in such a way as to be accessible from the action classification apparatus 10.

“Any number of frames” refers to that the number of frames is not limited to one predetermined number, and may be any number among a plurality of options. Specifically, the number of frames in which a human movement extracted in the present example embodiment is presented is not limited to one fixed value, for example, such as “five frames”, and may be any number within a numerical range set with a specific width, for example, such as “any of 5 to 20 frames”.

The above-described numerical range may be defined optionally according to a required performance. The larger the numerical range is, the smaller a limit on the number of frames can be. By defining this numerical range sufficiently wide, limitation on the number of frames can be virtually eliminated. Meanwhile, when the numerical range is too wide, there will be human movements of which difference in the number of frames from each other is very large, and computation of a similarity of movements and the like become troublesome. When the numerical range is narrowed down to a certain extent, there will not be human movements of which difference in the number of frames from each other is very large, and computation of a similarity of movements and the like become easier.

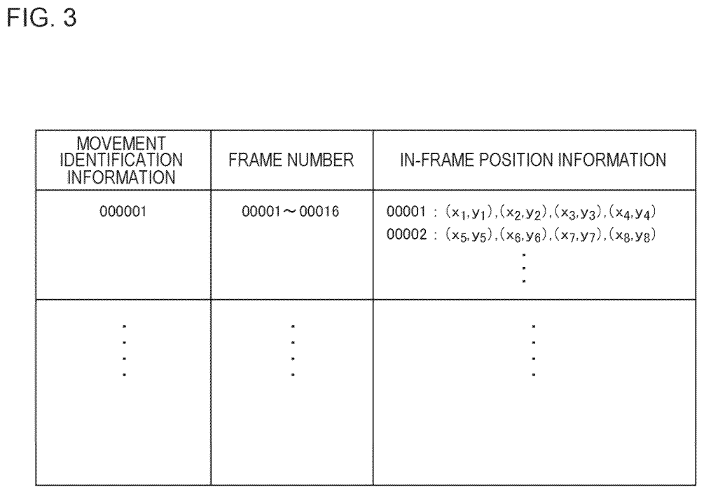

One example of an extraction result stored in the storage unit is schematically illustrated in FIG. 3. In the illustrated example, movement identification information, a frame number, and in-image position information are associated with each other.

The movement identification information is information for identifying the plurality of human movements detected by the extraction unit 11 from each other. A new piece of movement identification information is issued each time a new human movement is extracted.

The frame number is a number of frame in which each of the extracted human movements is presented. In the example illustrated in FIG. 3, a human movement determined by movement identification information “000001” is presented in frames of which frame numbers are “00001 to 00016”.

The in-image position information is information indicating where a person making each of the movements is located in each frame. In the illustrated example, a position of a person making each of the movements is indicated by coordinates of four vertices of a rectangle enclosing the person making the movement, but this method is one example and a position of a person in a frame may be indicated in another method.

Note that, although the extraction result illustrated in FIG. 3 is on a premise that a plurality of human movements are extracted from a single moving image file, a plurality of human movements may be extracted from a plurality of moving image files and stored in the storage unit. In this case, in the extraction result as illustrated in FIG. 3, identification information of a moving image file from which each of the human movements is extracted may be registered in association with the movement identification information.

There are various means by which the extraction unit 11 extracts, from a moving image, a human movement presented in any number of frames, and any technique can be employed. For example, for each of a plurality of human movements, a user may give an input, to the action classification apparatus, specifying a start frame and an end frame of any number of frames in which the human movement is presented, and a position of a person making the movement in each of the frames. Further, the extraction unit 11 may extract the plurality of human movements from a moving image, based on a user input, and store an extraction result in the storage unit.

Alternatively, a human movement presented in any number of frames may be extracted from a moving image by arithmetic operation processing by a computer without a user input specifying a start frame, an end frame, and a position in a frame as described above. One example of a means for achieving by arithmetic operation processing by a computer will be described in the following example embodiment.

Returning to FIG. 2, the time-series feature value computation unit 12 computes, for each of the human movements extracted by the extraction unit 11, a feature value of a human pose in each of the any number of frames, and thereby computes a time-series feature value in which the feature values for the any number of frames are aligned in time-series. Further, the time-series feature value computation unit 12 stores the computed time-series feature value of the any number of frames in the above-described storage unit.

Herein, processing by the time-series feature value computation unit 12 is described in more detail by taking a movement determined by the movement identification information “000001” illustrated in FIG. 3 as an example. In this example, the time-series feature value computation unit 12 processes each one of 16 frames with frame numbers “00001 to 00016”, and computes a feature value of a human pose in each of the frames. Note that, the time-series feature value computation unit 12 is capable of not targeting, for analysis, the entirety of each frame, and of targeting, for analysis, only an area in which a person making the movement exists that is indicated by the in-frame position information in FIG. 3. Thus, by computing a feature value of a human pose in each of the frames, based on each of the 16 frames, 16 feature values of human poses can be acquired. By aligning those 16 feature values of human poses in a time-series order of the 16 frames, a time-series feature value for the 16 frames can be acquired.

In the present example embodiment, any technique can be employed as a means for computing a feature value of a human pose. One example thereof will be described in the following example embodiment.

Returning to FIG. 2, the similarity computation unit 13 computes a similarity between a plurality of time-series feature values. Note that, it is conceivable of a case in which two time-series feature values for which a similarity is computed are time-series feature values for a same number of frames, and a case in which the two time-series feature values are time-series feature values for different numbers of frames. After determining whether two time-series feature values for which a similarity is computed are time-series feature values for a same number of frames, the similarity computation unit 13 can compute a similarity between the two time-series feature values by using a method according to a determination result.

A means for computing a similarity between two time-series feature values for a same number of frames is not particularly limited, and any technique can be employed. For example, the similarity computation unit 13 may compute a similarity between two time-series feature values by using the technique disclosed in Patent Document 1.

Alternatively, the similarity computation unit 13 may determine a frame of one time-series feature value being relevant to each frame of the other time-series feature value, for example, based on an order of appearance of the frames. The similarity computation unit 13 associates frames of a same order of appearance with each other. Further, the similarity computation unit 13 may compute, for each pair of frames relevant to each other, a similarity of feature values of human poses, and compute a statistical value (an average value, a median value, a mode, a maximum value, a minimum value, or the like) of the similarity computed for each of a plurality of the pairs, as a similarity between the two time-series feature values.

Meanwhile, when two time-series feature values for which a similarity is computed are time-series feature values for different numbers of frames, the similarity computation unit 13 may compute a similarity between the two time-series feature values by using a “technique for computing a similarity between sets that differ from each other in number of elements”. Note that, in the following example embodiment, another example of a means for computing a similarity between two time-series feature values for different numbers of frames will be described.

The classification unit 14 classifies the plurality of human movements extracted by the extraction unit 11, by grouping similar movements together, based on the similarity between the plurality of time-series feature values computed by the similarity computation unit 13. There are various classification methods and, for example, a plurality of human movements of which similarity between time-series feature values of each other is equal to or more than a reference value may be classified into a same cluster (a group of similar movements).

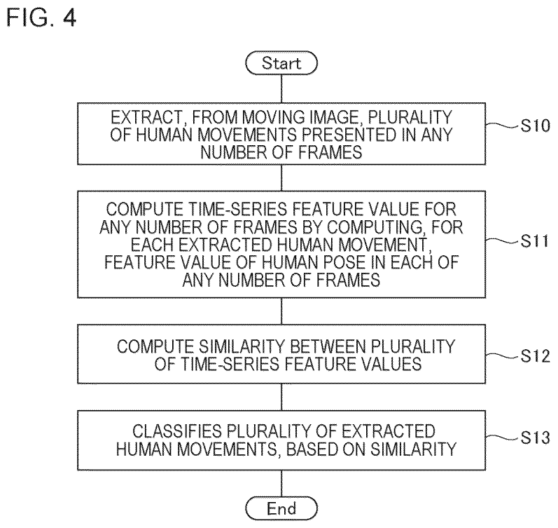

Next, one example of a flow of processing by the action classification apparatus 10 will be described with reference to a flowchart in FIG. 4.

First, the action classification apparatus 10 extracts, from a moving image, a plurality of human movements presented in any number of frames (S10). Next, the action classification apparatus 10 computes, for each of the human movements extracted in S10, a feature value of a human pose in each of the any number of frames, and thereby computes a time-series feature value for the any of frames (S11). Next, the action classification apparatus 10 computes a similarity between a plurality of the time-series feature values (S12). Then, the action classification apparatus 10 classifies, based on the similarity computed in S12, the plurality of extracted human movements (S13).

### “Advantageous Effect”

The action classification apparatus 10 according to the present example embodiment computes a similarity between human movements presented in any number of frames, and classifies the plurality of human movements by collecting similar movements, based on a computation result. In a case of the present example embodiment, a movement to be classified may be presented in any number of frames. In comparison to a case in which the number of frames in which a movement to be classified is presented is limited to one specific value, convenience is improved.

### Second Example Embodiment

According to an action classification apparatus 10 of the present example embodiment, processing of extracting, from a moving image, a plurality of human movements presented in any number of frames is automated. Detailed description will be given in the following.

An extraction unit 11 detects, from a moving image, a plurality of persons appearing consecutively in any number of frames, by using a tracking engine that tracks a same person. Further, the extraction unit 11 extracts, as a human movement presented in the any number of frames, a movement of each of the plurality of persons that is presented in the any number of frames and is detected by the tracking engine.

The tracking engine tracks a same person, based on at least one of a feature value of a face, a feature value of an outfit, a feature value of a possessed item, a feature value of a pose of the person, and a position in a frame.

The tracking engine may determine that a person is the same person, for example, when feature values of faces are similar to each other at or above a reference level. Further, the tracking engine may determine that a person is the same person when feature values of outfits are similar to each other at or above a reference level. Further, the tracking engine may determine that a person is the same person when feature values of possessed items are similar to each other at or above a reference level.

Further, the tracking engine may determine that a person is the same person when poses in two frames that are consecutive in a time-series order are similar to each other at or above a reference level. Further, the tracking engine may determine that a person is the same person when in-frame positions in two frames that are consecutive in the time-series order are similar to each other at or above a reference level.

Further, the tracking engine may determine a person is the same person when an integrated similarity computed based on similarities of feature values of any two or more of the above-described plurality of types is equal to or more than a reference value. Examples of the integrated similarity include, but are not limited to, an average value, a maximum value, a minimum value, a mode, a median value, a weighted average value, a weighted sum, and the like of similarities of feature values of two or more types. When an integrated similarity is computed, it is desirable that similarities of feature values of the plurality of types are normalized and are made to be comparable.

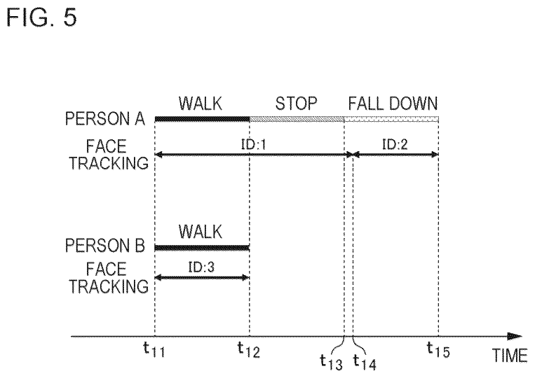

A specific example of processing by the extraction unit 11 is described with reference to FIG. 5. In the illustrated example, a person is detected from a moving image by using a face tracking engine. The face tracking engine detects a person A and a person B from the moving image.

The person A appears in the moving image from a time t₁₁ to a time t₁₅.

Further, the person A walks from the time t₁ to a time t₁₂, stops from the time t₁₂ to a time t₁₃, and falls down from the time t₁₃ to the time t₁₅.

The person B appears in the moving image from the time t₁ to the time t₁₂. Further, the person B walks from the time t₁₁ to the t₁₂.

When such a moving image is processed by the face tracking engine, for example, from the time t₁₁ to a time t₁₄, the person A is tracked as a same person, but at the time t₁₄, for some reason (for example, a feature value of a face can no longer acquired sufficiently because the person A has fallen), tracking on person A is once stopped. Further, from the time t₁₄ to t₁₅, the person A is tracked while being recognized as a different person from the person who had been tracked from the time t₁₁ to t₁₄. As a result, the person A from the time t₁₁ to t₁₄ is assigned with one piece of person identification information (“ID: 1” in the diagram), and the person A from the time t₁₄ to t₁₅ is assigned with another piece of person identification information (“ID: 2” in the diagram).

Further, from the time t₁₁ to t₁₂, the person B is tracked as a same person. As a result, the person B from the time t₁ to t₁₂ is assigned with one piece of person identification information (“ID: 3” in the diagram).

On a basis of a result of such tracking by the face tracking engine, the extraction unit 11 extracts a movement made by the person A (“ID: 1” in the diagram) from the time t₁₁ to t₁₄ as one human movement, extracts a movement made by the person A (“ID: 2” in the diagram) from the time t₁₄ to t₁₅ as another human movement, and extracts a movement made by the person B (“ID: 3” in the diagram) from the time t₁₁ to t₁₂ as yet another human movement.

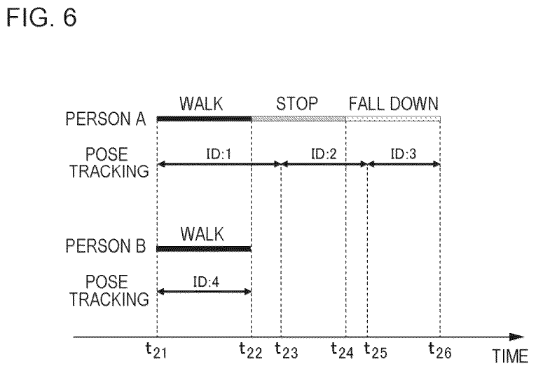

Another specific example of the processing by the extraction unit 11 is described in FIG. 6. In the illustrated example, a person is detected from a moving image by using a pose tracking engine. The moving image processed in the example in FIG. 6 is the same moving image as the moving image processed in the example in FIG. 5. As illustrated in FIGS. 5 and 6, even when the same moving image is processed, tracking results may vary depending on a type of a tracking engine used.

In the example in FIG. 6, the extraction unit 11 extracts a movement made by the person A (“ID: 1” in the diagram) from a time t₂₁ to a time t₂₃ as one human movement, extracts a movement made by the person A (“ID: 2” in the diagram) from the time t₂₃ to a time t₂₅ as another human movement, extracts a movement made by the person A (“ID: 3” in the diagram) from the time t₂₅ to a time t₂₆ as yet another human movement, and extracts a movement made by the person B (“ID: 4” in the diagram) from the time t₂₁ to a time t₂₂ as still yet another human movement.

Note that, when a person detected by the tracking engine consecutively appears in equal to or more than a predetermined upper limit number (matter of design) of frames, the extraction unit 11 may divide a plurality of frames in which the person consecutively appears into a plurality of groups by using any method, and extract each human movement presented in the plurality of frames belonging to each of the plurality of groups, as one human movement. In this case, one piece of movement identification information (see FIG. 3) is assigned to a human movement presented in a plurality of frames belonging to each group. Further, a human movement presented in a plurality of frames belonging to one group becomes one target of classification processing.

In the example in FIG. 5, the extraction unit 11 determines, for each of ID 1, ID 2, and ID 3, whether the number of frames in which a person associated with each ID appears consecutively exceeds an upper limit. The number of frames in which the person associated with ID 1 appears consecutively is the number of frames from the time t₁₁ to t₁₄. The number of frames in which the person associated with ID 2 appears consecutively is the number of frames from the time t₁₄ to t₁₅. The number of frames in which the person associated with ID 3 appears consecutively is the number of frames from the time t₁₁ to t₁₂.

A method for dividing a plurality of frames into a plurality of groups is not particularly limited, and the number of frames belonging to each group may be less than the predetermined upper limit number. For example, a predetermined number (less than the predetermined upper limit number) of frames may be grouped together in a time-series order of the plurality of frames into one group. Note that, one frame may belong in duplicate to a plurality of groups, or such duplication may not be allowed.

Further, when the number of frames in which the detected person appears consecutively is equal to or less than a predetermined lower limit number (matter of design), the extraction unit 11 may not extract a human movement presented in equal to or less than the lower limit number of frames as one human movement.

Other configurations of the action classification apparatus 10 according to the present example embodiment are similar to those in the first example embodiment.

According to the action classification apparatus 10 of the present example embodiment, an advantageous effect similar to that in the first example embodiment is achieved. Further, according to the action classification apparatus 10 of the present example embodiment, the processing of extracting, from a moving image, a plurality of human movements presented in any number of frames is automated. As a result, convenience is improved.

### Third Example Embodiment

In the present example embodiment, a means for computing a feature value of a human pose is embodied. Detailed description is as follows. A time-series feature value computation unit 12 includes a skeleton structure detection unit and a feature value computation unit.

The skeleton structure detection unit executes processing of detecting N (N is an integer equal to or greater than two) key points of a human body included in a frame. The processing by the skeleton structure detection unit is achieved by using the technique disclosed in Patent Document 1. Although details are omitted, in the technique disclosed in Patent Document 1, detection of a skeleton structure is performed by using a skeleton estimation technique such as OpenPose disclosed in Non-Patent Document 1. The skeleton structure detected by using the technique consists of a “key point” being a characteristic point such as a joint and a “bone (bone link)” indicating a link between the key points.

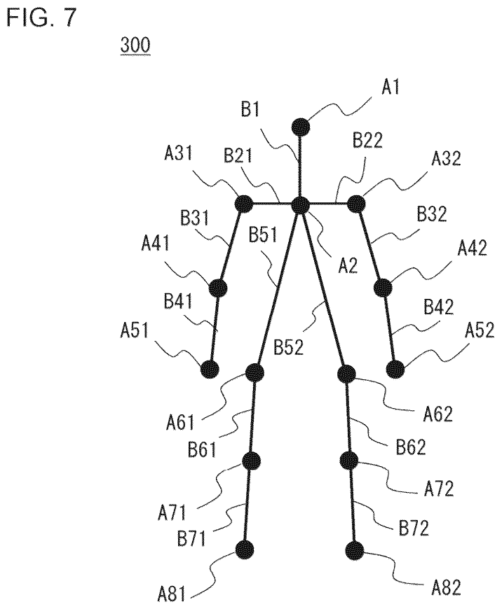

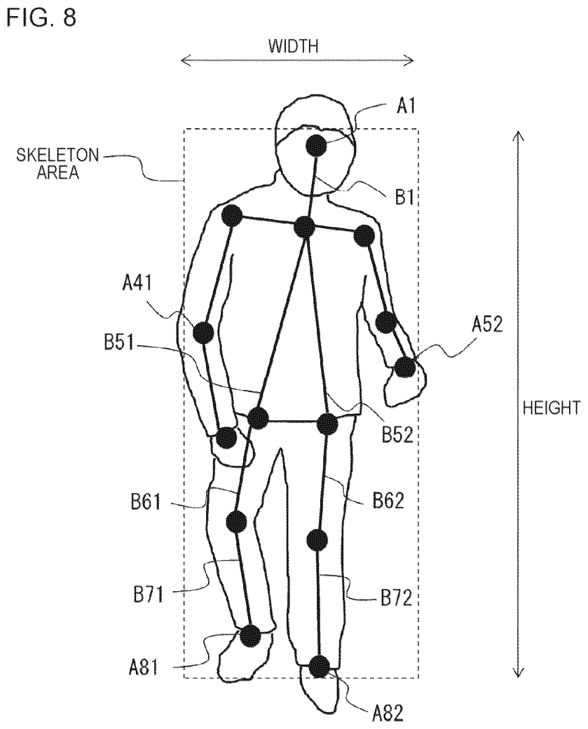

FIG. 7 illustrates a skeleton structure of a human body model 300 detected by the skeleton structure detection unit, and FIGS. 8 to 10 illustrates an example of skeleton structure detection. The skeleton structure detection unit detects, by using a skeleton estimation technique such as OpenPose, a skeleton structure of the human body model (two-dimensional skeleton model) 300 such as illustrated in FIG. 7 from a two-dimensional image. The human body model 300 is a two-dimensional model consisted of a key point such as a joint of a person and a bone connecting each of the key points.

The skeleton structure detection unit extracts a keypoint that may be a key point, for example, from an image, and detects N key points of a human body by referring to information acquired by performing machine learning on an image of the key point. The N key points to be detected is defined in advance. The number of key points to be detected (specifically, the number of N) and which part of the human body is a key point to be detected are vary, and any variation can be employed.

In the example in FIG. 7, a head A1, a neck A2, a right shoulder A31, a left shoulder A32, a right elbow A41, a left elbow A42, a right hand A51, a left hand A52, a right waist A61, a left waist A62, a right knee A71, a left knee A72, a right foot A81, and a left foot A82 are detected as key points of a person. Further, a bone B1 connecting the head A1 and the neck A2, a bone B21 connecting the neck A2 and the right shoulder A31, a bone B22 connecting the neck A1 and the left shoulder A32, a bone B31 connecting the right shoulder A31 and the right elbow A41, a bone B32 connecting the left shoulder A32 and the left elbow A42, a bone B41 connecting the right elbow A41 and the right hand A51, a bone B42 connecting the left elbow A42 and the left hand A52, a bone B51 connecting the neck A2 and the right waist A61, a bone B52 connecting the neck A2 and the left waist A62, a bone B61 connecting the right waist A61 and the right knee A71, a bone B62 connecting the left waist A62 and the left knee A72, a bone B71 connecting the right knee A71 and the right foot A81, and a bone B72 connecting the left knee A72 and the left foot A82 are detected as bones of a person acquired by connecting the key points. FIG. 8 illustrates an example in which a person in a standing-up state is detected. In FIG. 8, an image of a person standing-up is captured from a front, each of the bone B1, the bone B51 and the bone B52, the bone B61 and the bone B62, and the bone B71 and the bone B72 viewed from the front is detected without overlapping with each other, and the bone B61 and the bone B71 of the right foot slightly bend more than the bone B62 and the bone B72 of the left foot.

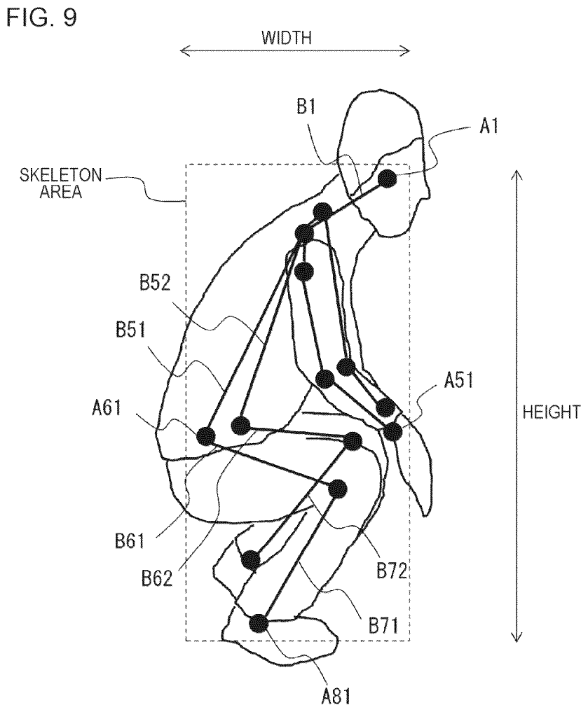

FIG. 9 illustrates an example in which a person in a squatting-down state is detected. In FIG. 9, an image of a person squatting-down is captured from a right side, each of the bone B1, the bone B51 and the bone B52, the bone B61 and the bone B62, and the bone B71 and the bone B72 viewed from the right side is detected, and the bone B61 and the bone B71 of the right foot and the bone B62 and the bone B72 of the left foot heavily bend and overlap with each other.

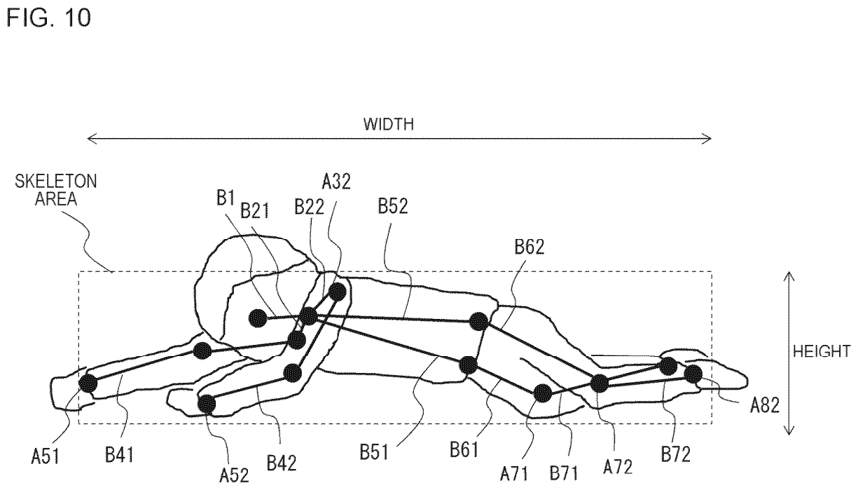

FIG. 10 illustrates an example in which a parson in a sleeping state is detected. In FIG. 10, an image of a sleeping person is captured from diagonally forward left, each of the bone B1, the bone B51 and the bone B52, the bone B61 and the bone B62, and the bone B71 and the bone B72 viewed from diagonally front left is detected, and the bone B61 and the bone B71 of the right foot and the bone B62 and the bone B72 of the left foot bend and overlap with each other.

The feature value computation unit computes a feature value of the detected two-dimensional skeleton structure. For example, the feature value computation unit computes a feature value of each of the detected key points.

A feature value of a skeleton structure indicates a feature of a skeleton of a person, and is an element for classifying a state (a pose or a movement) of the person, based on the skeleton of the person. Usually, the feature value includes a plurality of parameters. Further, the feature value may be a feature value of an entire skeleton structure, may be a feature value of a part of the skeleton structure, or may include a plurality of feature values such as a feature value of each part of the skeleton structure. A computation method of the feature value may be any method such as machine learning or normalization, and a minimum value and a maximum value may be determined as normalization. As one example, the feature value is a feature value acquired by machine learning on the skeleton structure, a size of the skeleton structure from a head portion to a foot portion on an image, a relative positional relationship between a plurality of key points in a vertical direction in a skeleton area including the skeleton structure on the image, a relative positional relationship between a plurality of key points in a horizontal direction in the skeleton area, and the like. The size of the skeleton structure is a height of the vertical direction, an area, or the like of the skeleton area including the skeleton structure on the image. The vertical direction (a height direction or a longitudinal direction) is an up/down direction (Y-axis direction) in the image, and, for example, is a direction perpendicular to a ground (reference plane). Further, the horizontal direction (a lateral direction) is a left/right direction (X-axis direction) in the image, and, for example, is a direction parallel to the ground.

Note that, in order to perform classification desired by a user, it is preferable to use a feature value having robustness against classification processing. For example, when a user desires classification independent of an orientation or a body shape of a person, a feature value being robust against an orientation and a body shape of a person may be used. The feature value independent of an orientation or a body shape of a person can be acquired by learning skeletons of persons in a same pose facing various orientations and skeletons of persons of various body shapes in a same pose, or by extracting only a feature of the vertical direction of a skeleton.

The above-described processing by the feature value computation unit is achieved by using the technique disclosed in Patent Document 1.

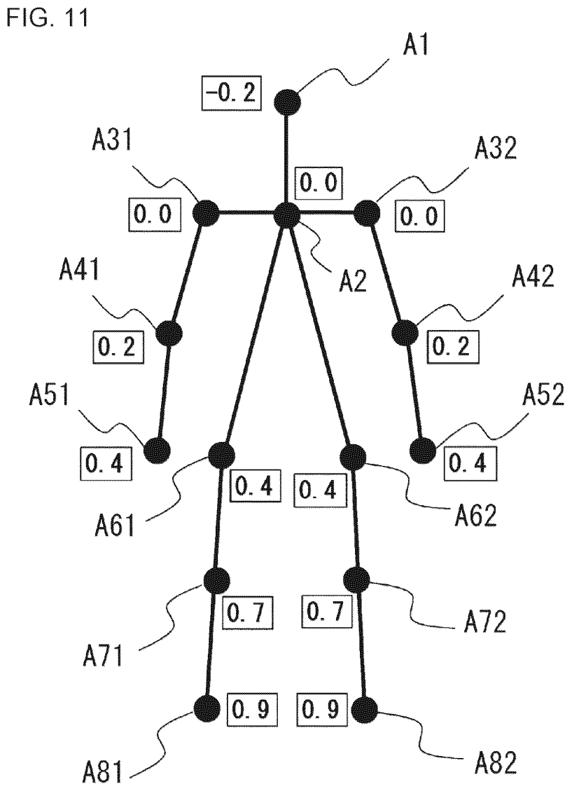

FIG. 11 illustrates an example of a feature value of each of a plurality of key points determined by the feature value computation unit. Note that, the feature value of the key point illustrated herein is merely one example, and is not limited thereto.

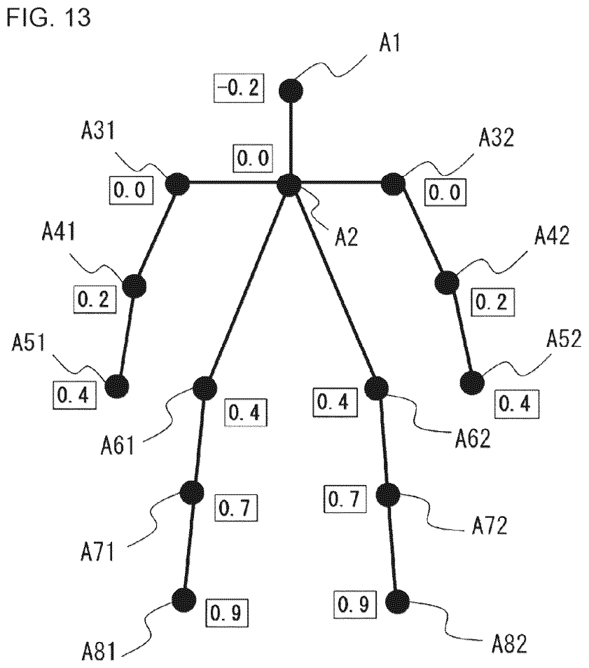

In this example, a feature value of a key point indicates a relative positional relationship between a plurality of key points in a vertical direction in a skeleton area including a skeleton structure on an image. Since the key point A2 of the neck is used as a reference point, a feature value of the key point A2 is 0.0, and feature values of the key point A31 of the right shoulder and the key point A32 of the left shoulder at a same height as the neck are also 0.0. A feature value of the key point A1 of the head at a higher position than the neck is −0.2. Feature values for the key point A51 of the right hand and the key point A52 of the left hand at positions lower than the neck are 0.4, and feature values of the key point A81 of the right foot and the key point A82 of the left foot are 0.9. When the person raises the left hand from this state, as illustrated in Fig, 12, the left hand becomes higher than the reference point, and therefore the feature value of the key point A52 of the left hand becomes −0.4. Meanwhile, since normalization is performed by using only a Y-axis coordinate, the feature value does not change even when a width of the skeleton structure changes as in FIG. 13 compared with FIG. 11. Specifically, the feature value (normalized value) in this example indicates a feature in a height direction (Y direction) of the skeleton structure (key point), and is not affected by a change in a lateral direction (X direction) of the skeleton structure.

There are various methods for computing a similarity of poses indicated by such a feature value. For example, after a similarity of feature values is computed for each of the key points, a similarity of poses may be computed based on a plurality of feature values of the key points. For example, an average value, a maximum value, a minimum value, a mode, a median value, a weighted average value, a weighted sum, or the like of the plurality of feature values of the key points may be computed as a similarity of poses. When a weighted average value or a weighted sum is computed, a weight of each key point may be set by a user, or may be defined in advance.

Other configurations of an action classification apparatus 10 according to the present example embodiment is similar to those in the first and second example embodiments.

According to the action classification apparatus 10 of the present example embodiment, an advantageous effect similar to that in the first and second example embodiments is achieved. Further, according to the action classification apparatus 10 of the present example embodiment, a similarity of pose can be computed with high accuracy. As a result, accuracy of action classification is improved.

### Fourth Example Embodiment

In the present example embodiment, a means for computing a similarity between two time-series feature values for different numbers of frames is embodied. Detailed description is as follows.

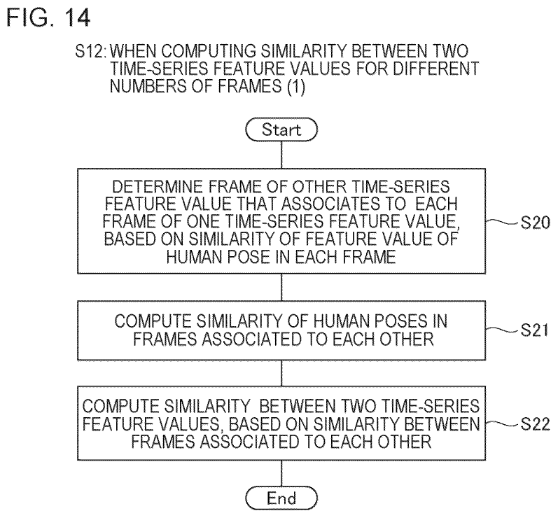

When computing a similarity between two time-series feature values for different numbers of frames, a similarity computation unit 13 computes the similarity between the two time-series feature values by executing processing illustrated in a flowchart in FIG. 14.

In S20, the similarity computation unit 13 determines, based on a similarity of feature value of a human pose in each frame, a frame of the other time-series feature value that associates to each frame of one time-series feature value. Detailed description is as follows.

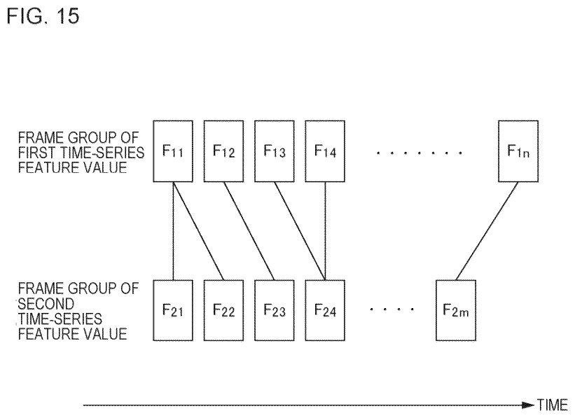

The similarity computation unit 13 searches, from the frames of the other time-series feature value, one or a plurality of frames in which a pose similar (a similarity is equal to or more than a threshold value) to a human pose in one first frame of the one time-series feature value is presented and associates the searched one or a plurality of frames with the first frame. One example of a result of determining a correlation is illustrated in FIG. 15. In FIG. 15, frames associated with each other are connected by a line. As illustrated, one frame may be associated with a plurality of frames. Also, one frame may be associated with one frame.

The above-described determination of a correlation can be achieved, for example, by using a technique such as dinamic time warping (DTW). In such a case, as a distance score required in the determination of the correlation, a distance (a Manhattan distance, a Euclidean distance, or the like) between feature values, and the like can be used.

Returning to FIG. 14, in S21, the similarity computation unit 13 computes a similarity between feature values of human poses in frames that associate to each other. Specifically, the similarity computation unit 13 computes, for each pair of associated frames, a similarity of feature values of human poses.

In S22, the similarity computation unit 13 computes a similarity between the two time-series feature values, based on the similarity computed in S21. The similarity computation unit 13 computes, for example, a statistic value (an average value, a median value, a mode, a maximum value, a minimum value, or the like) of the similarity computed for each of the plurality of pairs, as the similarity between the two time-series feature values.

Other configurations of an action classification apparatus 10 according to the present example embodiment is similar to those in the first to third example embodiments.

According to the action classification apparatus 10 of the present example embodiment, an advantageous effect similar to that in the first to third example embodiments is achieved. Further, according to the action classification apparatus 10 of the present example embodiment, a similarity between two time-series feature values for different numbers of frames can be computed with high accuracy. As a result, convenience is improved.

### Fifth Example Embodiment

In the present example embodiment, a means for computing a similarity between two time-series feature values for different numbers of frames is embodied in a method different from that in the fourth example embodiment. Detailed description is as follows.

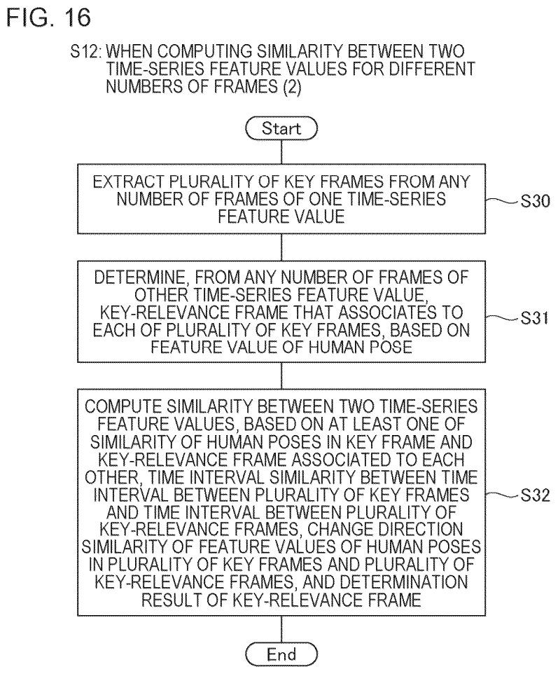

When computing a similarity between two time-series feature values for different numbers of frames, a similarity computation unit 13 computes the similarity between the two time-series feature values by executing processing illustrated in a flowchart in FIG. 16.

In S30, the similarity computation unit 13 extracts a plurality of key frames from any number of frames of one time-series feature value.

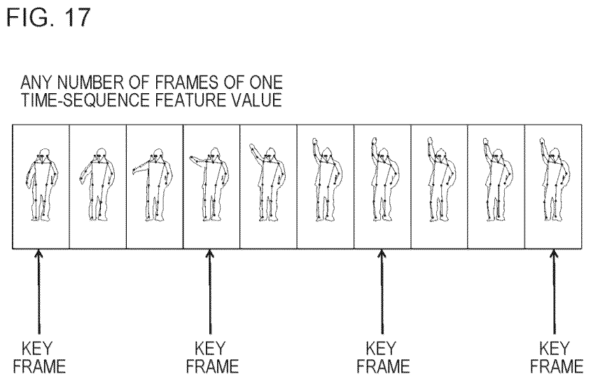

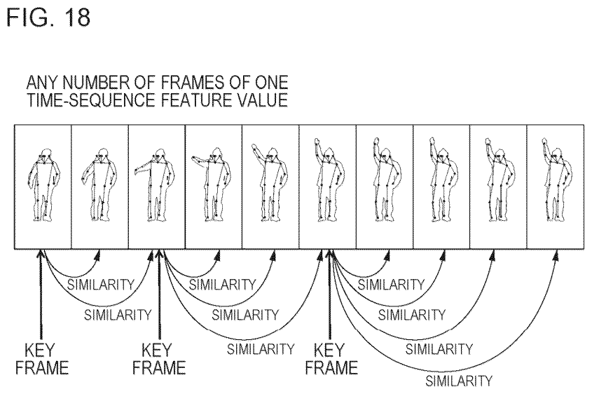

The “key frames” are some frames among the any number of frames of the one time-series feature value. As illustrated in FIGS. 17 and 18, the similarity computation unit 13 can intermittently extract key frames from a plurality of frames in time-series. A time interval (the number of frames) between the key frames may be constant or varied. The similarity computation unit 13 can execute, for example, any of the following extraction processing 1to 3.

### Extraction Processing 1

In the extraction processing 1, the similarity computation unit 13 extracts a key frame, based on a user input. Specifically, a user gives an input specifying some of the plurality of frames as the key frames. Then, the similarity computation unit 13 extracts the frame specified by the user as the key frame.

### Extraction Processing 2

In the extraction processing 2, the similarity computation unit 13 extracts the key frame in accordance with a predetermined rule.

Specifically, as illustrated in FIG. 17, the similarity computation unit 13 extracts a plurality of key frames from the plurality of frames at a predetermined fixed interval. Specifically, the similarity computation unit 13 extracts a key frame at every M frames. M is an integer and, for example, is an integer equal to or more than 2 and equal to or less than 10, but is not limited thereto. M may be defined in advance, or may be selected by a user.

### Extraction Processing 3

In extraction processing 3, the similarity computation unit 13 extracts the key frame in accordance with a predetermined rule.

Specifically, as illustrated in FIG. 18, after extracting one key frame (for example, a first frame), the similarity computation unit 13 computes a similarity between the extracted one key frame and each frame subsequent to the one key frame in time-series order. The similarity is a similarity of a pose of a human body included in each frame. A means for computing a similarity of pose is not particularly limited, and, for example, the means described in the third example embodiment can be employed. Then, the similarity computation unit 13 extracts a frame of which a similarity is equal to or less than a reference value (matter of design) and is most early in the time-series order, as a new key frame.

Next, the similarity computation unit 13 computes a similarity between the newly extracted key frame and each frame subsequent to the newly extracted key frame in the time-series order. Then, the similarity computation unit 13 extracts a frame of which a similarity is equal to or less than the reference value (matter of design) and is most early in the time-series order, as a new key frame. The similarity computation unit 13 repeats the processing, and thereby extracts the plurality of key frames. According to the processing, poses of the human body in adjacent key frames are different from each other to some extent. Thus, the plurality of key frames in which characteristic poses of the human body are presented can be extracted while suppressing an increase in the number of the key frames. The above-described reference value may be defined in advance, may be selected by a user, or may be set by another means.

Returning to FIG. 16, in S31, the similarity computation unit 13 determines, from any number of frames of the other time-series feature value, a key-relevance frame that associates to each of the plurality of key frames extracted in S30, based on a feature value of a human pose.

The “key-relevance frame” is a frame that includes a human body in a pose being equally or more similar to a pose of a human body included in a key frame than a predetermined level. A means for computing a similarity of a pose is not particularly limited, and, for example, the means described in the third example embodiment can be employed. When Q (Q is an integer of 2 or more) key frames are extracted, Q key-relevance frames associated to each of the Q key frames are extracted.

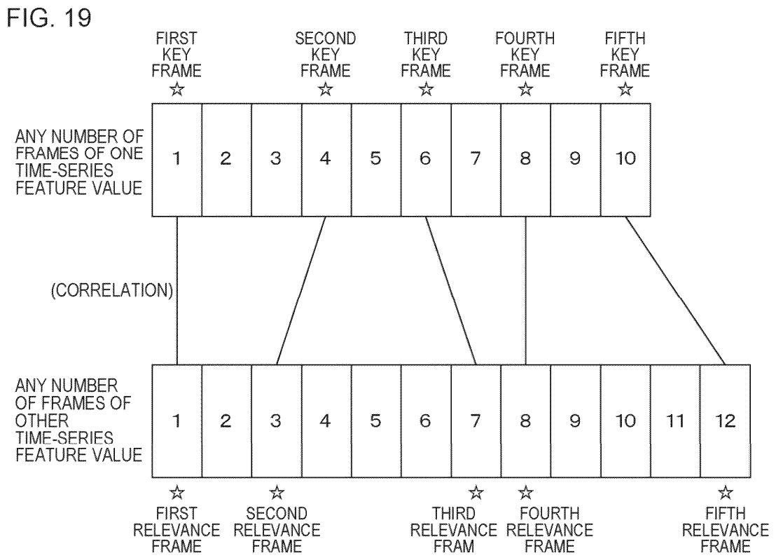

In FIG. 19, the number of the frames of the one time-series feature value is 10, from which five frames are extracted as the key frames. Specifically, first, fourth, sixth, eighth, and tenth frames marked with a star in the diagram are extracted as the key frames. Hereinafter, a key frame of which time-series order is N among a plurality of key frames is referred to as a “Nth key frame”. N is an integer of 1 or more. In the example in FIG. 19, among the frames of the one time-series feature value, the first frame is referred to as a first key frame, the fourth frame is referred to as a second key frame, the sixth frame is referred to as a third key frame, the eighth frame is referred to as a fourth key frame, and the tenth frame is referred to as a fifth key frame.

Further, in the example in FIG. 19, the number of the frames of the other time-series feature value is 12, from which five frames are extracted as the key-relevance frames. Specifically, first, third, seventh, eighth, and twelfth frames marked with a star in the diagram are determined as the key-relevance frames. Hereinafter, a key-relevance frame that associates to the Nth key frame is referred to as a “Nth key-relevance frame”. In the example in FIG. 19, among the frames of the other time-series feature value, the first frame is a first key-relevance frame, the third frame is a second key-relevance frame, the seventh frame is a third key-relevance frame, the eighth frame is a fourth key-relevance frame, and the twelfth frame is a fifth key-relevance frame.

Returning to FIG. 16, in S32, the similarity computation unit 13 computes, based on at least one of a pose similarity, a time interval similarity, a change direction similarity, and a determination result of a key-relevance frame, a similarity between the two time-series feature values. Detailed description is as follows.

### First Computation Method

In a first computation method, the similarity computation unit 13 computes a similarity between the two time-series feature values, based on a pose similarity.

The “pose similarity” is a similarity between a feature value of a human pose in each of a plurality of key frames and a feature value of a human pose in each of a plurality of key-relevance frames.

First, the similarity computation unit 13 computes, for each pair of a key frame and a key-relevance frame associated with each other, a similarity of feature values of human poses (pose similarity). A computation method of the pose similarity is not particularly limited, and, for example, the method described in the third example embodiment can be employed. Then, the similarity computation unit 13 computes a statistic value (an average value, a median value, a mode, a maximum value, a minimum value, and the like) of the pose similarity computed for each of a plurality of pairs, as the similarity between the two time-series feature values. Note that, the similarity computation unit 13 may compute, as the similarity between the two time-series feature value, a value acquired by standardizing the computed statistic value in accordance with a predetermined rule.

### Second Computation Method

In a second computation method, the similarity computation unit 13 computes a similarity between the two time-series feature values, based on a time interval similarity.

The “time interval similarity” is a similarity between a time interval between a plurality of key frames and a time interval between a plurality of key-relevance frames.

First, concepts of the “time interval between a plurality of key-relevance frames” and the “time interval between a plurality of key frames” are described with reference to FIG. 19.

In the illustrated example, the time interval between a plurality of key-relevance frames is a time interval between each of the first to fifth key-relevance frames.

For example, the time interval between the plurality of key-relevance frames may be a concept that includes a time interval between temporally adjacent key-relevance frames. In the example in FIG. 19, time intervals between temporally adjacent key-relevance frames are a time interval between the first and second key-relevance frames, a time interval between the second and third key-relevance frames, a time interval between the third and fourth key-relevance frames, and a time interval between the fourth and fifth key-relevance frames.

Alternatively, the time interval between the plurality of key-relevance frames may be a concept that includes a time interval between a temporally first key-relevance frame and a temporally last key-relevance frame. In the example in FIG. 19, the time interval between the temporally first key-relevance frame and the temporally last key-relevance frame is a time interval between the first and fifth key-relevance frames.

Alternatively, the time interval between the plurality of key-relevance frames may be a concept that includes a time interval between a reference key-relevance frame determined in any method and each of the other key-relevance frames. In the example in FIG. 19, for example, when the first key-relevance frame is the reference key-relevance frame, the time intervals between the reference key-relevance frame and each of the other key-relevance frames are a time interval between the first and second key-relevance frames, a time interval between the first and third key-relevance frames, a time interval between the first and fourth key-relevance frames, and a time interval between the first and fifth key-relevance frames. Note that, the reference key-relevance frame may be one or plural.

The “time interval between a plurality of key-relevance frames” may be any one of the above-described plurality of types of time intervals, or may include a plurality of types of time intervals. It is preliminarily defined which of the above-described plurality of types of time intervals is to be the time interval between the plurality of key-relevance frames. In the example in FIG. 19, any one or a plurality of the time interval between the first and second key-relevance frames, the time interval between the second and third key-relevance frames, the time interval between the third and fourth key-relevance frames, and the time interval between the fourth and fifth key-relevance frames (these are the time intervals between temporally adjacent key-relevance frames), the time interval between the first and the fifth key-relevance frames (the time interval between the temporally first key-relevance frame and the temporally last key-relevance frame), and the time interval between the first and second key-relevance frames, the time interval between the first and third key-relevance frames, the time interval between the first and fourth key-relevance frames, and the time interval between the first and fifth key-relevance frames (these are examples of the time intervals between a reference key-relevance frame and each of the other key-relevance frames) become the time interval between the plurality of key-relevance frames.

A concept of the time interval between the plurality of key frames is similar to the above-described concept of the time interval between the plurality of key-relevance frames.

Note that, a time interval between two frames may be indicated by the number of frames in between the two frames, or may be indicated by an elapsed time between the two frames computed based on the number of frames between the two frames and a frame rate.

Next, computation method of the time interval similarity will be described. When the time interval between the plurality of key-relevance frames and the time interval between the plurality of key frames are one type of time intervals, the similarity computation unit 13 computes a difference in the time intervals as the time interval similarity. The difference in the time intervals is a gap or a variation rate. Note that, the similarity computation unit 13 may compute a value acquired by standardizing the computed difference in the time intervals in accordance with a predetermined rule, as the time interval similarity. In this example, the computed time interval similarity is the similarity between the two time-series feature values.

Meanwhile, when the time interval between a plurality of relevance frames and the time interval between the plurality of key frames include a plurality of types of time intervals, first, the similarity computation unit 13 computes, for each type of time interval, a difference in the time intervals, as the time interval similarity. The difference in the time intervals is a gap or a variation rate. After that, the similarity computation unit 13 computes a statistic value of the time interval similarity computed for each type of time interval, as the similarity between the two time-series feature values. Examples of the statistic value include an average value, a maximum value, a minimum value, a mode, a median value, and the like, but are not limited thereto. Note that, the similarity computation unit 13 may compute a value acquired by standardizing the computed statistic value in accordance with a predetermined rule, as the similarity between the two time-series feature values.

### Third Computation Method

In a third computation method, the similarity computation unit 13 computes a similarity between the two time-series feature values, based on a change direction similarity.

The “change direction similarity” is a similarity between a direction of change in a feature value of a human pose in a plurality of key frames and a direction of change in a feature value of a human pose in a plurality of key-relevance frames.

First, the similarity computation unit 13 computes a direction of temporal change in a feature value of a human pose in a plurality of key frames in time-series. The similarity computation unit 13 computes a direction of change in a feature value of a human pose, for example, between key frames that are adjacent in time-series order.

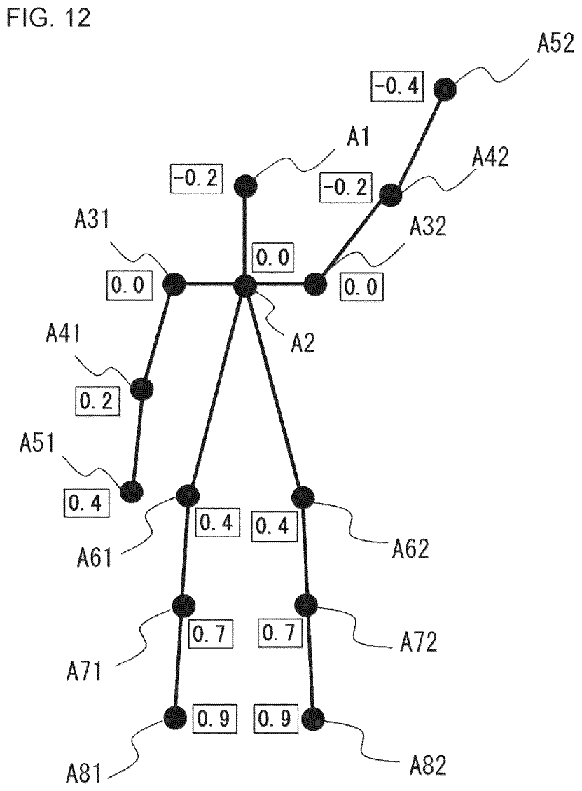

For example, the feature value may be a feature value of a key point that has been described with reference to FIGS. 11 to 13. In this case, the similarity computation unit 13 computes, for each key point, a direction of change in a numerical value. The direction of change in a numerical value is divided into three categories that are a “direction in which the numerical value increases”, “no change in the numerical value”, and a “direction in which the numerical value decreases”. “No change in the numerical value” may be a case in which an absolute value of a change amount of a feature value is zero, or may be a case in which the absolute value of the change amount of the feature value is equal to or less than a threshold value.

By computing the above-described direction of change in a numerical value between adjacent key frames, the similarity computation unit 13 can compute, for each key point, time-series data indicating a time-series change in a direction of change in a feature value. The time-series data are, for example, the “direction in which the numerical value increases”→the “direction in which the numerical value increases”→the “direction in which the numerical value increases”→“no change in the numerical value”→“no change in the numerical value”→the “direction in which the numerical value increases”, and the like. When the “direction in which the numerical value increases” is, for example, represented as “1”, “no change in the numerical value” is, for example, represented as “0”, and the “direction in which the numerical value decreases” is, for example, represented as “−1”, the time-series data can be represented as a numerical string, for example, “111001”.

Alternatively, a feature value of a pose may be indicated by a height and an area of a skeleton area, an angle of a predetermined joint (an angle formed by three key points), or the like. Also in this case, a direction of change in a numerical value is divided into three categories that are a “direction in which the numerical value increases”, “no change in the numerical value”, and a “direction in which the numerical value decreases”. Further, when three or more key frames are to be processed, as descried above, the similarity computation unit 13 can compute time-series data indicating a time-series change in the direction of change in a feature value.

The similarity computation unit 13 computes a similarity (change direction similarity) between numerical strings computed as described above, as the similarity between the two time-series feature values. Note that, the similarity computation unit 13 may compute a value acquired by standardizing, in accordance with a predetermined rule, the similarity (change direction similarity) between the numerical strings computed as described above, as the similarity between the two time-series feature values. A computation method of a similarity of two numerical string rolls is not particularly limited, and, for example, a method in which a numerical string is regarded as a character string and a similarity between the two character strings is computed may be employed.

Further, when a plurality of types of the above described numerical strings are computed, (for example, a numerical string for each key point, a numerical string of angles of a plurality of joints, and the like), after computing a similarity (change direction similarity) between each type of numerical string, the similarity computation unit 13 computes a statistic value of the similarity between each type of numerical string, as the similarity between the two time-series feature values. The statistic value is an average value, a maximum value, a minimum value, a mode, a median value, a weighted average value, a weighted sum, or the like, but is not limited thereto. When a weighted average value and a weighted sum is computed, a weight of each type of numerical string may be set by a user, or may be defined in advance.

### Fourth Computation Method

In a fourth computation method, the similarity computation unit 13 computes a similarity between the two time-series feature values, based on a determination result of a key-relevance frame.

As described above, a key-relevance frame is a frame that includes a human body in a pose being equally or more similar to a pose of a human body included in a key frame than a predetermined level. When there are Q key frames, Q key-relevance frames may be determined, or a smaller number of key-relevance frames may be determined. Further, a time-series order of the Q key frames and a time-series order of the determined plurality of key-relevance frames may be identical, or may be different. The similarity computation unit 13 computes the similarity between the two time-series feature values, based on this viewpoint.

For example, the similarity computation unit 13 determines whether a same number of key-relevance frames as the key frames are determined. Then, the similarity computation unit 13 computes the similarity between the two time-series feature values, based on a result of the determination. When the same number of key-relevance frames as the key frames are determined, the similarity computation unit 13 computes a similarity higher than that in a case in which fewer key-relevance frames than key frames are determined. Further, when fewer key-relevance frames than key frames are determined, the similarity computation unit 13 computes a higher similarity as the number of determined key-relevance frames is greater. An algorithm for computing a similarity based on this criterion is not particularly limited, and any method can be employed.

Alternatively, the similarity computation unit 13 computes a similarity between a time-series order of the plurality of key frames and a time-series order of the plurality of key-relevance frames, as the similarity between the two time-series feature values. A computation method of the similarity between the time-series orders is not particularly limited, and, for example, a method described in the following may be employed.

The time-series order of the plurality of key frames can be indicated by using the above-described value of N, for example, as a numerical string such as “12345”. This numerical string indicates that the time-series order of the first to fifth key frames is “the first key frame→the second key frame→the third key frame→the fourth key frame→the fifth key frame”. Likewise, a time-series order of the plurality of key-relevance frames can also be indicated by using the above-described value of N, for example, as a numerical string such as “12435”. This numerical string indicates that the time-series order of the first to fifth key-relevance frames is “the first key-relevance frame→the second key-relevance frame→the fourth key-relevance frame→the third key-relevance frame→the fifth key frame”. Further, the similarity computation unit 13 may compute a similarity between the time-series order of the plurality of key frames and the time-series order of the plurality of key-relevance frames by using a method in which the numerical string is regarded as a character string and a similarity between the two character strings is computed.

### Fifth Computation Method

In a fifth computation method, the similarity computation unit 13 computes a similarity between the two time-series feature values by using a plurality of the first to fourth computation method.

The similarity computation unit 13 standardizes similarities computed in any plurality of the first to fourth computation method, in such a way as to be comparable to each other. Then, the similarity computation unit 13 computes a statistic value of the similarities computed in each of the computation methods, as the similarity between the two time-series feature values. The statistic value is an average value, a maximum value, a minimum value, a mode, a median value, a weighted average value, a weighted sum, or the like, but is not limited thereto. When a weighted average value and a weighted sum is computed, a weight of the similarity computed in each type of computation method may be set by a user, or may be defined in advance.

Other configurations of an action classification apparatus 10 according to the present example embodiment is similar to those in the first to third example embodiments.

According to the action classification apparatus 10 of the present example embodiment, an advantageous effect similar to that in the first to third example embodiments is achieved. Further, according to the action classification apparatus 10 of the present example embodiment, a similarity between two time-series feature values for different numbers of frames can be computed with high accuracy. As a result, accuracy of action classification is improved.

### Sixth Example Embodiment

An action classification apparatus 10 according to the present example embodiment outputs a characteristic user interface (UI) screen. Detailed description is as follows.

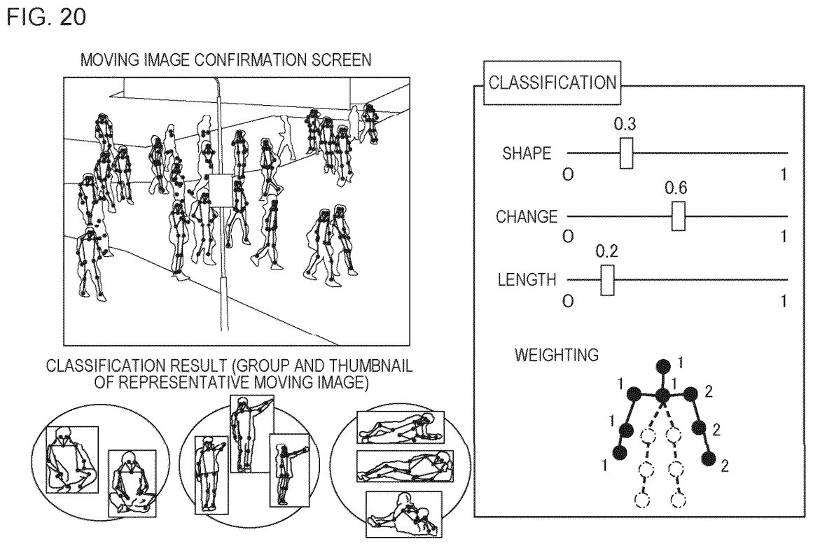

A classification unit 14 displays a UI screen as illustrated in FIG. 20 on a display. The illustrated UI screen includes an area in which a moving image confirmation screen is displayed, an area in which a classification result is displayed, and an area in which a UI component for receiving a user input that specifies various weights.

In the area in which a classification result is displayed, a result of classifying a plurality of human movements extracted by an extraction unit 11 is displayed. As described above, the classification unit 14 generates a plurality of clusters by grouping together similar movements of the plurality of human movements extracted by the extraction unit 11. In the example in FIG. 20, representative thumbnail of human movements belonging to each cluster is displayed for each cluster. In the example in FIG. 20, three clusters are displayed. Further, two or three representative thumbnails are displayed for each of the clusters.

As a selection method of a representative, (1) a method of selecting a predetermined number of representatives in order from closest to a center of a cluster, (2) a method of selecting a predetermined number of representatives at random, and the like are conceivable. Further, a predetermined condition such as excluding overlapping movements of the same person from being representative may be set. A computation method of a center of a cluster is not particularly limited, and any technique can be employed.

An analyzed moving image is reproduced on the moving image confirmation screen. A reproduction position can be specified by a user. For example, a user may give an input of selecting one thumbnail from the illustrated classification result. Further, the classification unit 14 may reproduce the moving image from a beginning of a scene including a selected human movement (or from a predetermined time before that point). Note that, in the illustrated example, a key point and a bone detected from each person are superimposed on each person, but the key point and the bone may or may not be displayed.

In the area in which a UI component for receiving a user input that specifies various weights, sliders each corresponding to “shape” “change”, and “length” are displayed. Further, a weight can be specified within a range of zero to one for each of “shape”, “change”, and “length”. The “shape” corresponds to a pose similarity described in the fifth example embodiment. The “change” corresponds to a change direction similarity described in the fifth example embodiment. The “length” corresponds to a time interval similarity described in the fifth example embodiment.

Note that, in this example, the three weights that are the pose similarity, the change direction similarity, and the time interval similarity can be specified, but this is one example, and a weight that can be specified is not limited thereto. Further, a weight of a determination result of a key-relevance frame described in the fifth example embodiment may be specifiable, and any two types of weights may be specifiable.

Further, in the illustrated example, a weight for each of a plurality of key points can be specified. In the diagram, 1 and 2 displayed in association with each key point are the weight of each key point. Further, a key point that is not filled in black indicates that a weight is zero (not considered in similarity computation). For example, a user gives a predetermined input for each key point, and can thereby set a weight for each key point, as illustrated. Further, the user can recognize various weights that have been set so far, from the illustrated screen.

Note that, when a user gives an input that changes various weights to the illustrated UI component, in response to the input, a similarity computation unit 13 may re-compute a similarity, based on a newly set weight. Then, the classification unit 14 may re-classify the plurality of human movements extracted from the moving image, based on the newly computed similarity, and update the illustrated classification result to a new classification result.

Other configurations of the action classification apparatus 10 according to the present example embodiment is similar to those in the first to fifth example embodiments.

According to the action classification apparatus 10 of the present example embodiment, an advantageous effect similar to that in the first to fifth example embodiments is achieved. Further, according to the action classification apparatus 10 of the present example embodiment, a user can easily set various weights, and easily recognize current settings. Further, a user can easily recognize a classification result.

Although the example embodiments of the present invention has been described with reference to the drawings, these are examples of the present invention and various configurations other than the above-described configurations can also be employed. The configurations of the above-described example embodiments may be combined with each other, and may be partially replaced with another configuration. Further, various modifications may be added to the configurations of the above-descried example embodiments without departing from the scope. Further, the configuration and the processing disclosed in each of the above-described example embodiments and modification examples may be combined with each other.

Further, a plurality of steps (pieces of processing) are described in order in a plurality of flowcharts in the above description, but an execution order of steps executed in each example embodiment is not limited to the described order. In each example embodiment, the illustrated order of steps can be changed to an extent that contents of the steps are not interfered with. Further, each of the above-described example embodiments can be combined to an extent that contents of each example embodiments do not conflict with each other.

A part or the entirety of the above-described example embodiments may be described as the following supplementary notes, but is not limited thereto.
1. An action classification apparatus including:
   an extraction unit that extracts, from a moving image, a plurality of human movements presented in any number of frames;
   a time-series feature value computation unit that computes a time-series feature value for any number of frames by computing, for each of the extracted human movements, a feature value of a human pose in each of the any number of frames;
   a similarity computation unit that computes a similarity between a plurality of the time-series feature values; and
   a classification unit that classifies a plurality of extracted human movements, based on the similarity.
2. The action classification apparatus according to supplementary note 1, wherein,
   when computing a similarity between the two time-series feature values for different numbers of frames,
   the similarity computation unit
      determines a frame of the other time-series feature value associated to each frame of the one time-series feature value, based on a similarity of a feature value of a human pose in each frame, and
      computes a similarity between the two time-series feature values, based on a similarity of feature values of human poses in frames associated to each other.
3. The action classification apparatus according to supplementary note 1, wherein,
   when computing a similarity between the two time-series feature values for different numbers of frames,
   the similarity computation unit
   extracts a plurality of key frames from the any number of frames of the one time-series feature value,
   determines, from the any number of frames of the other time-series feature value, a key-relevance frame associated to each of the plurality of key frames, based on a feature value of a human pose, and
   computes a similarity between the two time-series feature values, based on at least one of a pose similarity being a similarity between a feature value of a human pose in each of the plurality of key frames and a feature value of a human pose in each of a plurality of the key-relevance frames, a time interval similarity being a similarity between a time interval between the plurality of key frames and a time interval between the plurality of key-relevance frames, a change direction similarity being a similarity between a direction of change in feature values of human poses in the plurality of key frames and a direction of change in feature values of human poses in the plurality of key-relevance frames, and a determination result of the key-relevance frame.
4. The action classification apparatus according to supplementary note 3, wherein
   the similarity computation unit
   computes a similarity between a plurality of the time-series feature values, based on a plurality of types of similarities among the pose similarity, the time interval similarity, and the change direction similarity, and
   computes a similarity between a plurality of the time-series feature values, based on a weight being set for each of the plurality of types of similarities.
5. The action classification apparatus according to supplementary note 4, wherein
   the similarity computation unit computes a similarity between a plurality of the time-series feature values, based on a weight of each of the plurality of types of similarities being set via a user input.
6. The action classification apparatus according to any one of supplementary notes 1 to 5, wherein
   the extraction unit
   detects, from the moving image, a plurality of persons consecutively appearing in any number of frames, by using a tracking engine that tracks a same person, and
   extracts a movement presented by each of the plurality of detected persons in the any number of frames, as a movement presented in the any number of frames.
7. The action classification apparatus according to supplementary note 6, wherein,
   when a number of frames in which the detected person appears consecutively is equal to or less than a lower limit number, the extraction unit does not extract a movement presented in frames equal to or less than the lower limit number, as a movement presented in the any number of frames.
8. The action classification apparatus according to supplementary note 6 or 7, wherein,
   when the detected person appears consecutively in equal to or more than an upper limit number of frames, the extraction unit divides a plurality of frames in which the person consecutively appears into a plurality of groups, and extracts each human movement presented in a plurality of frames belonging to each of a plurality of groups, as a human movement presented in the any number of frames.
9. An action classification method including,
   by a computer, executing:
   an extraction step of extracting, from a moving image, a plurality of human movements presented in any number of frames;
   a time-series feature value computation step of computing a time-series feature value for any number of frames by computing, for each of the extracted human movements, a feature value of a human pose in each of the any number of frames;
   a similarity computation step of computing a similarity between a plurality of the time-series feature values; and
   a classification step of classifying a plurality of extracted human movements, based on the similarity.
10. A program causing a computer to function as:
   an extraction unit that extracts, from a moving image, a plurality of human movements presented in any number of frames;
   a time-series feature value computation unit that computes a time-series feature value for any number of frames by computing, for each of the extracted human movements, a feature value of a human pose in each of the any number of frames;
   a similarity computation unit that computes a similarity between a plurality of the time-series feature values; and
   a classification unit that classifies a plurality of extracted human movements, based on the similarity.

### Reference Signs List

10 Action classification apparatus
11 Extraction unit
12 Time-series feature value computation unit
13 Similarity computation unit
14 Classification unit
1A Processor
2A Memory
3A Input/output I/F
4A Peripheral circuit
5A Bus

What is claimed is:

1. An action classification apparatus comprising:
at least one memory configured to store one or more instructions; and
at least one processor configured to execute the one or more instructions to:
extract, from a moving image, a plurality of human movements presented in any number of frames;
compute a time-series feature value for any number of frames by computing, for each of the extracted human movements, a feature value of a human pose in each of the any number of frames;
computes compute a similarity between a plurality of the time-series feature values; and
classify a plurality of extracted human movements, based on the similarity.

2. The action classification apparatus according to claim 1, wherein the at least one processor is further configured to execute the one or more instructions to,
when computing a similarity between the two time-series feature values for different numbers of frames,
determine a frame of the other time-series feature value associated to each frame of the one time-series feature value, based on a similarity of a feature value of a human pose in each frame, and
compute a similarity between the two time-series feature values, based on a similarity of feature values of human poses in frames associated to each other.

3. The action classification apparatus according to claim 1, wherein the at least one processor is further configured to execute the one or more instructions to,
when computing a similarity between the two time-series feature values for different numbers of frames,
extract a plurality of key frames from the any number of frames of the one time-series feature value,
determine, from the any number of frames of the other time-series feature value, a key-relevance frame associated to each of the plurality of key frames, based on a feature value of a human pose, and
compute a similarity between the two time-series feature values, based on at least one of a pose similarity being a similarity between a feature value of a human pose in each of the plurality of key frames and a feature value of a human pose in each of a plurality of the key-relevance frames, a time interval similarity being a similarity between a time interval between the plurality of key frames and a time interval between the plurality of key-relevance frames, a change direction similarity being a similarity between a direction of change in feature values of human poses in the plurality of key frames and a direction of change in feature values of human poses in the plurality of key-relevance frames, and a determination result of the key-relevance frame.

4. The action classification apparatus according to claim 3, wherein
the at least one processor is further configured to execute the one or more instructions to
compute a similarity between a plurality of the time-series feature values, based on a plurality of types of similarities among the pose similarity, the time interval similarity, and the change direction similarity, and
compute a similarity between a plurality of the time-series feature values, based on a weight being set for each of the plurality of types of similarities.

5. The action classification apparatus according to claim 4, wherein
the at least one processor is further configured to execute the one or more instructions to comute a similarity between a plurality of the time-series feature values, based on a weight of each of the plurality of types of similarities being set via a user input.

6. The action classification apparatus according to claim 1, wherein
the at least one processor is further configured to execute the one or more instructions to
detect, from the moving image, a plurality of persons consecutively appearing in any number of frames, by using a tracking engine that tracks a same person, and
extract a movement presented by each of the plurality of detected persons in the any number of frames, as a movement presented in the any number of frames.

7. The action classification apparatus according to claim 6, wherein the at least one processor is further configured to execute the one or more instructions to,
when a number of frames in which the detected person appears consecutively is equal to or less than a lower limit number, not extract a movement presented in frames equal to or less than the lower limit number, as a movement presented in the any number of frames.

8. The action classification apparatus according to claim 6, wherein the at least one processor is further configured to execute the one or more instructions to,
when the detected person appears consecutively in equal to or more than an upper limit number of frames, divide a plurality of frames in which the person consecutively appears into a plurality of groups, and extract each human movement presented in a plurality of frames belonging to each of a plurality of groups, as a human movement presented in the any number of frames.

9. An action classification method comprising,
by a computer, executing:
extracting, from a moving image, a plurality of human movements presented in any number of frames;
computing a time-series feature value for any number of frames by computing, for each of the extracted human movements, a feature value of a human pose in each of the any number of frames;
computing a similarity between a plurality of the time-series feature values; and
classifying a plurality of extracted human movements, based on the similarity.

10. A non-transitory storage medium storing a program causing a computer to
extract, from a moving image, a plurality of human movements presented in any number of frames;
compute a time-series feature value for any number of frames by computing, for each of the extracted human movements, a feature value of a human pose in each of the any number of frames;
compute a similarity between a plurality of the time-series feature values; and
classify a plurality of extracted human movements, based on the similarity.

11. The action classification method according to claim 9, wherein,
when computing a similarity between the two time-series feature values for different numbers of frames,
the computer
determines a frame of the other time-series feature value associated to each frame of the one time-series feature value, based on a similarity of a feature value of a human pose in each frame, and
computes a similarity between the two time-series feature values, based on a similarity of feature values of human poses in frames associated to each other.

12. The action classification method according to claim 9, wherein,
when computing a similarity between the two time-series feature values for different numbers of frames,
the computer
extracts a plurality of key frames from the any number of frames of the one time-series feature value,
determines, from the any number of frames of the other time-series feature value, a key-relevance frame associated to each of the plurality of key frames, based on a feature value of a human pose, and
computes a similarity between the two time-series feature values, based on at least one of a pose similarity being a similarity between a feature value of a human pose in each of the plurality of key frames and a feature value of a human pose in each of a plurality of the key-relevance frames, a time interval similarity being a similarity between a time interval between the plurality of key frames and a time interval between the plurality of key-relevance frames, a change direction similarity being a similarity between a direction of change in feature values of human poses in the plurality of key frames and a direction of change in feature values of human poses in the plurality of key-relevance frames, and a determination result of the key-relevance frame.

13. The action classification method according to claim 12, wherein
the computer
computes a similarity between a plurality of the time-series feature values, based on a plurality of types of similarities among the pose similarity, the time interval similarity, and the change direction similarity, and
computes a similarity between a plurality of the time-series feature values, based on a weight being set for each of the plurality of types of similarities.

14. The action classification method according to claim 13, wherein
the computer computes a similarity between a plurality of the time-series feature values, based on a weight of each of the plurality of types of similarities being set via a user input.

15. The action classification method according to claim 9, wherein
the computer
detects, from the moving image, a plurality of persons consecutively appearing in any number of frames, by using a tracking engine that tracks a same person, and
extracts a movement presented by each of the plurality of detected persons in the any number of frames, as a movement presented in the any number of frames.

16. The non-transitory storage medium according to claim 10, wherein the program causing the computer to,
when computing a similarity between the two time-series feature values for different numbers of frames,
determine a frame of the other time-series feature value associated to each frame of the one time-series feature value, based on a similarity of a feature value of a human pose in each frame, and
compute a similarity between the two time-series feature values, based on a similarity of feature values of human poses in frames associated to each other.

17. The non-transitory storage medium according to claim 10, wherein the program causing the computer to,
when computing a similarity between the two time-series feature values for different numbers of frames,
extract a plurality of key frames from the any number of frames of the one time-series feature value,
determine, from the any number of frames of the other time-series feature value, a key-relevance frame associated to each of the plurality of key frames, based on a feature value of a human pose, and
compute a similarity between the two time-series feature values, based on at least one of a pose similarity being a similarity between a feature value of a human pose in each of the plurality of key frames and a feature value of a human pose in each of a plurality of the key-relevance frames, a time interval similarity being a similarity between a time interval between the plurality of key frames and a time interval between the plurality of key-relevance frames, a change direction similarity being a similarity between a direction of change in feature values of human poses in the plurality of key frames and a direction of change in feature values of human poses in the plurality of key-relevance frames, and a determination result of the key-relevance frame.

18. The non-transitory storage medium according to claim 17, wherein
the program causing the computer to
compute a similarity between a plurality of the time-series feature values, based on a plurality of types of similarities among the pose similarity, the time interval similarity, and the change direction similarity, and
compute a similarity between a plurality of the time-series feature values, based on a weight being set for each of the plurality of types of similarities.

19. The non-transitory storage medium according to claim 18, wherein
the program causing the computer to compute a similarity between a plurality of the time-series feature values, based on a weight of each of the plurality of types of similarities being set via a user input.

20. The non-transitory storage medium according to claim 10, wherein
the program causing the computer to
detect, from the moving image, a plurality of persons consecutively appearing in any number of frames, by using a tracking engine that tracks a same person, and
extract a movement presented by each of the plurality of detected persons in the any number of frames, as a movement presented in the any number of frames.
